(19) United States
(12) Patent Application Publication
(10) Pub. No.: US 2006/0170231 A1
(43) Pub. Date: Aug. 3, 2006

(54) Digging apparatus with expanded foot interface

(76) Inventors: Steve Brown, Woodinville, WA (US); James Lucy, Seattle, WA (US)

Correspondence Address: CENTRAL COAST PATENT AGENCY, PO BOX 187, AROMAS, CA, 95004, US

(21) Appl. No.: 11/343,374

(22) Filed: Jan. 30, 2006

Related U.S. Application Data
(60) Provisional application No. 60/649,655, filed on Feb. 2, 2005.

(51) Int. Cl. A01B 1/00

(52) U.S. Cl. 294/60

(57) ABSTRACT

A digging apparatus has a blade end and a handle having a central axis mounted to the blade end. The blade end has at least one substantially planar interface area for a user's foot substantially orthogonal to the central axis of the handle, the interface area equal to or greater than six square inches.

### CROSS-REFERENCE TO RELATED APPLICATIONS

The present application claims priority to provisional application 60/649,655, filed on Feb. 2, 2005, and incorporates all disclosure of the prior application by reference.

### STATEMENT REGARDING FEDERALLY SPONSORED RESEARCH OR DEVELOPMENT

Not Applicable

### BACKGROUND OF THE INVENTION

1. Field of the Invention

The present invention relates in general to spades and shovels and other digging apparatus of the type for urging into the ground with the aid of a user's weight with a foot on a rear portion of the apparatus, and pertains more particularly to such an apparatus with a new and novel interface for the user's foot.

2. Discussion of the State of the Art

Spades and shovels and other digging apparatus of many sorts are very well-known in the art of the general type to which the present invention belongs. In general these prior art tools have a handle portion, typically wooden or plastic, and a metal blade portion with a forward end that comes to an apex so only a small length of metal, generally a point, is originally presented to the earth, and the edge presented becomes greater as the shovel enters the earth.

Typically the metal blade portion of such an apparatus has a region near where the handle attaches to the blade portion for a user to place a foot, and to add the user's weight to urge the blade portion into the earth. This region typically extends at a right angle to the direction of use and to each side of the handle attachment. This region in some cases is of the thickness of the metal used to fashion the blade portion, and in some cases may be rolled or blunted, but typically has a width in the direction of the thickness of the blade portion of a quarter of an inch or less.

In use the user's weight is concentrated along an edge of relatively small length, and the narrow width of the rearward portion of the blade of such a digging apparatus so the user may transfer at least a portion of his/her weight to the apparatus to urge the blade portion into the earth. After sinking the blade into the earth, the user removes his foot and used the handle as a lever to loosen the earth, which he may then pick up with the digging apparatus to cast aside.

An unmet need in apparatus spades of this sort is a comfortable and efficient interface for the user's foot. The relatively narrow edge of the blade portions of prior art digging tools, even though most people may wear relatively heavy footware when using them, concentrates a user's weight in a narrow line across the sole of the user's shoe or boot. The inevitable result is an uncomfortable situation for the user, excessive wear on the footware, and a possibility also of a sprained or broken ankle, or other damage to the user's foot.

What is needed is a new and novel interface integrated with such tools to spread the user's weight over a broader area, making the effect one of a lower weight per unit area, with perhaps anti-slip features as well. The invention described below solves this difficulty.

### SUMMARY OF THE INVENTION

In an embodiment of the invention a digging apparatus is provided, comprising a blade end and a handle having a central axis mounted to the blade end. The blade end has at least one substantially planar interface area for a user's foot substantially orthogonal to the central axis of the handle, the interface area equal to or greater than six square inches.

In one embodiment the interface area has integrated non-slip elements. Also in one embodiment the blade end has two interface areas, one implemented to each side of the handle interface, each interface area equal to or greater than six square inches.

In various embodiments of the invention digging apparatus is one of a shovel, a spade, a spading fork, or a mutt. In one embodiment the digging apparatus is a shovel, the interface area is a raised back wall of the blade end of the shovel, and the shovel additionally comprises sidewalls.

In another aspect of the invention a removable foot interface for a digging apparatus having a handle with an axis and a blade end with a back edge at a right angle to the handle axis is provided, comprising at least one foot plate having a substantially planar area of at least six square inches, one or more first engagement elements joined to the foot plate for engaging the back edge of the blade end, and a second engagement element for engaging the handle. With the engagement elements engaged to the handle and back edge of the blade end the foot plate planar area is presented proximate the back edge of the blade end substantially orthogonal to the handle axis and to one side of the handle axis.

In one embodiment the interface area has integrated non-slip elements. Also in one embodiment the foot plate extends to each side of the handle axis, and has a total area of at least twelve square inches, one half of the area extending to each side of the axis. In various embodiments the digging apparatus is one of a shovel, a spade, a spading fork, or a mutt.

### BRIEF DESCRIPTION OF THE DRAWING FIGURES

FIG. 1a is a perspective view of a shovel according to an embodiment of the present invention.

FIG. 1b is a side view of the shovel of FIG. 1a.

FIG. 2a is a perspective view of a shovel according to prior art proximate an attachable foot interface according to an embodiment of the present invention.

FIG. 2b is a side view of the elements of FIG. 2a showing attachment geometry.

### DESCRIPTION OF THE PREFERRED EMBODIMENTS

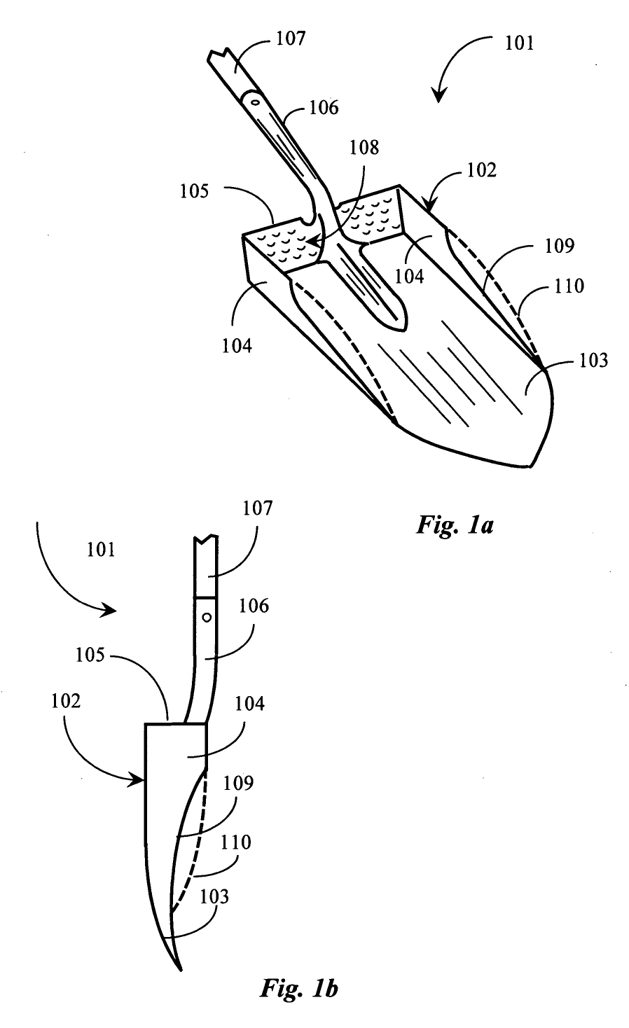

FIG. 1a and 1b illustrate a spade/shovel 101 according to an embodiment of the present invention, which consists essentially of a formed metal blade end 102 and a handle 107 that fastens into an elongated tubular portion 106 of blade end 102. FIG. 1a is a perspective view and FIG. 1b is a side elevation view of the spade/shovel according to an embodiment of the invention. Both figures are useful and should be used to understand the invention.

In the embodiment illustrated the formed end 102 comprises a substantially flat and relatively broad surface 105 as an interface for a user's foot in use. Surface 105 extends the full width of the metal blade end and has a height in this embodiment of at about two inches. In other embodiments the height may be more or less than two inches. The inventors have found that the foot engagement edge of most prior art digging tools is seldom more than one quarter of an inch in width, and the length to one side of a handle is seldom more than six inches. So the area of such an interface is on the order of 1.5 square inches. Further the width of many boot soles is from 2.5 to 5 inches. Using three inches as an average, a two-inch wide by three inch long area provides an area of six square inches for user's foot, as opposed to about 1.5 square inches for the conventional case, a factor of four. The pressure per unit area is thus reduced using the embodiment described by a factor of four. If, for example, a user weighs 170 pounds, the pressure on the user's boot sole for the conventional case (assuming applying all of the user's weight) is about 114 pounds per square inch. For the embodiment of the invention described, the pressure is about 28 pounds per square inch. Accordingly the inventors believe an area of six square inches or more is preferable in embodiment of ht invention.

Raised sides 104 extend from surface 105 and are contiguous with bottom area 103 of the formed blade end 102. In the embodiment shown bottom area 103 may be arcuate both longitudinally and laterally as shown, or may be substantially planar, or may be arcuate in one direction only. Some arcuate feature is typically preferable in such tools. Sides 104 may have a straight portion as shown extending from surface 105, and may be arcuate thereafter away from surface 105 as shown by solid line 109. In an alternative embodiment the sides may curve in an opposite aspect as shown by dotted line 110. In other embodiments the sides may take other shapes. In some embodiments there may be no sides at all.

In a preferred embodiment the upper edge of sides 104 is sharpened as an aid in cutting into soil, and particularly for cutting any roots that may be encountered that may cross the path of the shovel in the general direction of the width of the shovel in use. The sides provide for a substantial partially enclosed volume so that the spade of the invention in use, in the embodiment that has such side regions, holds more excavated material than prior art spades and shovels.

An important feature of the invention is the foot interface 105, which, in preferred embodiment is substantially planar, and arranged so that the plane is substantially orthogonal to the long axis of handle 107. The angle can vary somewhat, say by ten to fifteen degrees, but the interface becomes generally less effective as the angle increases. An important purpose of area 105 is to provide a broad surface for a user to plant his or her shoe or boot in use, the broad area providing a lower weight per unit area in use than prior art spades and shovels. In some embodiments non-slip elements 108 may be molded into or added to surface 105 as an aid in preventing slipping, which can be dangerous in operation. Non-slip features may be added, for example, by weld spatter, by weld lines, or by punching holes into surface 105 in a pattern to leave portions of the surface raised above the original plane of the metal. There are many way for providing such non-slip features.

The shovel illustrated by FIGS. 1a and 1b is an original equipment product, and the novel features are formed in manufacture. The inventors realize, however, that there already exist millions of shovels and spades that are perfectly useful, but lack the features of the invention, and desires to bring the advantages of these novel features to owners and users of these prior art spades and shovels as well.

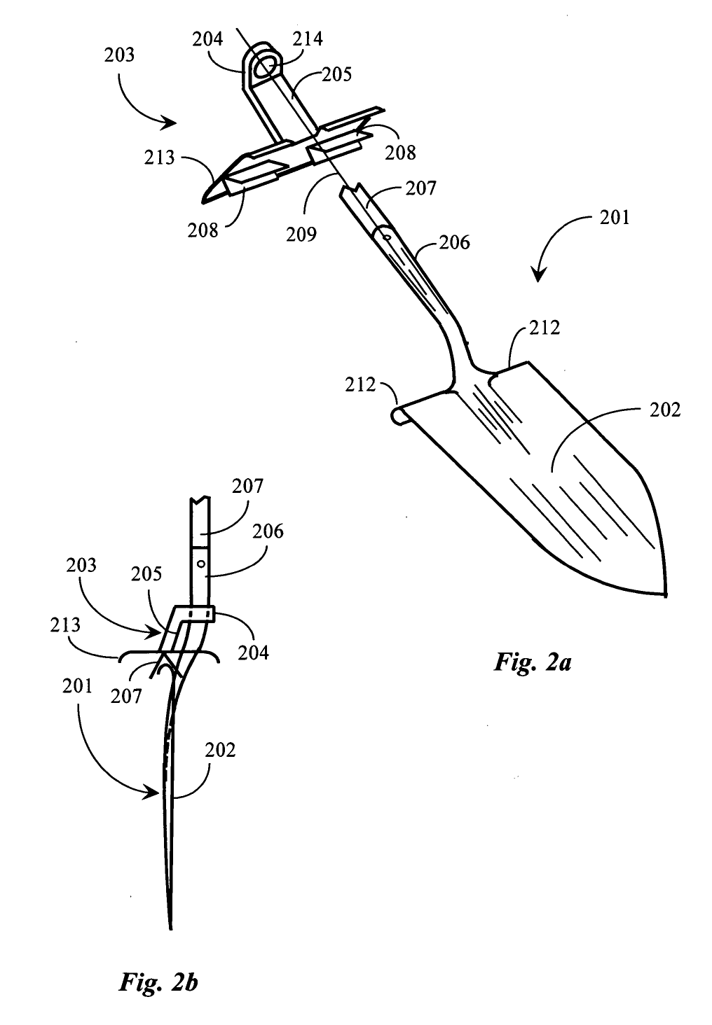

FIG. 2a is a perspective view of a conventional shovel 201 and a novel foot interface 202 in proximity. FIG. 2b is a side elevation view of the shovel 201 and foot interface 203 of FIG. 2a, with foot interface 203 in position for use with shovel 201. An object in this embodiment of the invention is to provide a useful foot interface for conventional shovels and spades already in use.

Conventional shovel 201 has a handle portion 207 attached via an attachment region 206 to a blade portion 202, which has rolled upper edges 212. Novel foot interface 203 comprises a foot plate 213 with rounded edges, engagement cradles 208 for engaging rounded edges 212 of shovel 201, and a handle engagement unit 204 with an opening 214 of a diameter larger than handle 207, joined to foot plate 213 by a bracket 205.

FIG. 2a shows foot interface 203 aligned with handle 207 along centerline 209. A user places opening 214 over the open end of the handle of the shovel, and slides the foot interface unit down to the blade potion 202, where engagement cradles 208 engage rolled edges 212.

FIG. 2b shows novel foot interface 203 in position with shovel 201, and engaged, such that the user may now place the foot on wide plate 213 on either side of handle 207, and use his/her weight to urge the blade portion of the shovel into the earth. Plate 213 now affords a wide and comfortable interface as opposed to rolled edges 212. In preferred embodiments the surface area provided for a user's foot is equal to or greater than 6 square inches, as described above for embodiments relating to FIGS. 1a and 1b. Further, in many embodiments anti-slip features may be provided for plate 213 as also described above.

It will be apparent to the skilled artisan that many features of the invention as described in examples above may be altered from the specifics shown without departing from the spirit and scope of the invention. For example, the wider and more comfortable foot interface, either in original equipment form or in the after-market form of unit 203 may be applied to shovels, spades, spading forks, pitch forks, mutts and other sorts of digging apparatus. Many sorts of materials may be used, and the skilled artisan will recognize that there are equivalent ways for engagement elements to be fashioned for a foot interface to become a part of an original equipment apparatus or to engage a conventional digging apparatus. Therefore the invention should be accorded the breadth of the claims that follow.

What is claimed is:

1. A digging apparatus comprising:
a blade end; and
a handle having a central axis mounted to the blade end;
wherein the blade end has at least one substantially planar interface area for a user's foot substantially orthogonal to the central axis of the handle, the interface area equal to or greater than six square inches.

2. The digging apparatus of claim 1 wherein the interface area has integrated non-slip elements.

3. The digging apparatus of claim 1 wherein the blade end has two interface areas, one implemented to each side of the handle interface, each interface area equal to or greater than six square inches.

4. The digging apparatus of claim 1 wherein the digging apparatus is one of a shovel, a spade, a spading fork, or a mutt.

5. The digging apparatus of claim 1 wherein the digging apparatus is a shovel, the interface area is a raised back wall of the blade end of the shovel, and the shovel additionally comprises sidewalls.

6. A removable foot interface for a digging apparatus having a handle with an axis and a blade end with a back edge at a right angle to the handle axis, comprising:
at least one foot plate having a substantially planar area of at least six square inches;
one or more first engagement elements joined to the foot plate for engaging the back edge of the blade end; and
a second engagement element for engaging the handle;
wherein, with the engagement elements engaged to the handle and back edge of the blade end the foot plate planar area is presented proximate the back edge of the blade end substantially orthogonal to the handle axis and to one side of the handle axis.

7. The foot interface of claim 6 wherein the interface area has integrated non-slip elements.

8. The foot interface of claim 6 wherein the foot plate extends to each side of the handle axis, and has a total area of at least twelve square inches, one half of the area extending to each side of the axis.

9. The foot interface of claim 6 wherein the digging apparatus is one of a shovel, a spade, a spading fork, or a mutt.
